(19) United States
(12) Patent Application Publication
(10) Pub. No.: US 2009/0254697 A1
(43) Pub. Date: Oct. 8, 2009

(54) MEMORY WITH EMBEDDED ASSOCIATIVE SECTION FOR COMPUTATIONS

(75) Inventors: Avidan Akerib, Tel-Aviv (IL); Eli Ehrman, Beth Shemesh (IL); Yoav Lavi, Raanana (IL); Moshe Meyassed, Kadima (IL)

Correspondence Address: DARBY & DARBY P.C., P.O. BOX 770, Church Street Station, New York, NY, 10008-0770, US

(73) Assignee: ZIKBIT LTD., Netanya (IL)

(21) Appl. No.: 12/119,197

(22) Filed: May 12, 2008

Related U.S. Application Data
(60) Provisional application No. 61/072,931, filed on Apr. 2, 2008.

(51) Int. Cl. G06F 12/00

(52) U.S. Cl. 711/105; 711/104; 711/E12.001

(57) ABSTRACT

An integrated circuit device includes a semiconductor substrate and an array of random access memory (RAM) cells, which are arranged on the substrate in first columns and are configured to store data. A computational section in the device includes associative memory cells, which are arranged on the substrate in second columns, which are aligned with respective first columns of the RAM cells and are in communication with the respective first columns so as to receive the data from the array of the RAM cells and to perform an associative computation on the data.

### CROSS-REFERENCE TO RELATED APPLICATIONS

This application claims the benefit of U.S. Provisional Patent Application 61/072,931, filed Apr. 2, 2008, whose disclosure is incorporated herein by reference. This application is related to U.S. patent application Ser. No. 12/113,475, entitled “Memory Device with Integrated Parallel Processing,” filed on or about May 1, 2008, which is assigned to the assignee of the present patent application and whose disclosure is incorporated herein by reference.

### FIELD OF THE INVENTION

The present invention relates generally to memory devices, and particularly to incorporation of parallel data processing functions in memory devices.

### BACKGROUND OF THE INVENTION

Various methods and systems are known in the art for accessing and processing data that are stored in memory. Some known methods and systems use content-addressable techniques, in which stored data are addressed by their content, rather than by storage address. Content-addressable techniques are also sometimes referred to as associative processing techniques. A parallel architecture for machine vision based on an associative processing approach is described, for example, in a Ph.D. thesis by Akerib, entitled “Associative Real-Time Vision Machine” (Department of Applied Mathematics and Computer Science, Weizmann Institute of Science, Rehovot, Israel, March, 1992), which is incorporated herein by reference.

The most common types of memory devices currently in use are random access memory (RAM) devices, such as dynamic random access memory (DRAM) and static random access memory (SRAM). A RAM device allows a memory circuit to read and write data by specifying the addresses of the data in the memory.

Content addressable memory (CAM) is a special type of memory device, which is typically used to accelerate applications requiring fast content searching. Searches in CAM devices are performed by simultaneously comparing an input data value (in the form of a string of bits in a comparand register) against the pre-stored entries in the memory. When the entry stored in a CAM memory location matches the data in the comparand register, a local match detection circuit returns a match indication. In addition, the CAM may return an address or addresses associated with the matched data. Binary CAM uses data search words composed entirely of ones and zeroes. Ternary CAM allows a third matching state of “X” or “Don't Care,” typically by adding a mask bit to every memory cell.

Some devices may include both RAM and CAM segments. For example, U.S. Pat. No. 3,685,020, whose disclosure is incorporated herein by reference, describes a compound memory that includes a random access array with an associative array as part of its accessing means. A match in the associative array between an effective address, identifying an addressed information block, and an associative array word directly energizes corresponding random access array locations that contain the addressed information block.

As another example, U.S. Pat. No. 5,706,224, whose disclosure is incorporated herein by reference, describes a semiconductor memory device that is partitionable into RAM and CAM subfields. Each of the CAM cells comprises a RAM cell attached to a comparator. The user may partition the memory array into a number of segments, some or all of which may be configured to function as simple RAM, rather than as CAM.

U.S. Pat. No. 6,195,738, whose disclosure is incorporated herein by reference, describes an architecture combining an associative processor memory array and a random access memory, which is used to store temporary results and parameters. Parallel communication between thousands of memory words in the associative memory array and the random access memory is provided via logic hardware.

### SUMMARY OF THE INVENTION

An embodiment of the present invention provides an integrated circuit device, which includes a semiconductor substrate and an array of random access memory (RAM) cells, which are arranged on the substrate in first columns and are configured to store data. A computational section of the device includes associative memory cells, which are arranged on the substrate in second columns, which are aligned with respective first columns of the RAM cells and are in communication with the respective first columns so as to receive the data from the array of the RAM cells and to perform an associative computation on the data.

In one embodiment, the RAM cells include dynamic RAM (DRAM) cells.

Typically, the computational section is configured to return a result of the associative computation to the array of the RAM cells, and the device includes control logic, which is coupled to receive a command from a host processor invoking the associative computation, and to issue, responsively to the command, a sequence of micro-commands that cause the computational section to perform the associative computation, and to return the result to the array of the RAM cells.

In some embodiments, the device includes control logic, which is configured to accept first commands from a host processor specifying addresses for reading and writing of the data in the array of the RAM cells, and to accept second commands, which cause the computational section to perform the associative computation on the data. The second commands may be memory-mapped to the addresses in the array of the RAM cells.

In disclosed embodiments, the first columns include first bit lines, each first column including a respective first bit line coupled to the RAM cells in the first column and a respective sense amplifier coupled to the first bit line, and each second column includes a respective second bit line, which is coupled to the respective sense amplifier of at least one of the first columns. Typically, the RAM cells and associative memory cells are arranged in respective first and second rows, and the sense amplifiers are configured to transfer the data simultaneously via the bit lines between the RAM cells in one of the first rows and all of the associative memory cells in one of the second rows. In one embodiment, the first columns are mutually spaced by a predetermined first pitch, and the second columns are mutually spaced by a second pitch, which is equal to the first pitch.

In a disclosed embodiment, each of the associative memory cells includes a storage cell, for holding a data bit, and compare logic, for performing a comparison between the data bit and a respective bit value of a comparand, and the second columns include respective tag cells, such that a tag cell in each second column is coupled to receive a result of the comparison from the compare logic and to write a new bit value to the storage cell of at least one of the associative memory cells in the second column responsively to the comparison. The tag cells may be coupled to transfer and receive data bits to and from the tag cells in neighboring columns, so as to apply a shift to the data.

In some embodiments, the associative memory cells are arranged in multiple rows and columns, and the computational section includes a comparand register, for holding a comparand, and is configured to make a comparison between the data held in each of the columns and the comparand, and to write data bits to one or more of the associative memory cells responsively to a result of the comparison. The computational section may include a mask register, for holding a mask, and may be configured to limit the comparison to the rows that are indicated by the mask. Additionally or alternatively, the computational section may be configured to write the data bits, responsively to the result of the comparison, so as to shift the data bits along at least one of the rows of the associative memory cells.

In one embodiment, the data stored in the array of the RAM cells include a sequence of data words, and the computational section is configured to read, compare and shift the data bits in the data words so as to transpose the data words from a row-wise to a column-wise orientation. The computational section may be configured to apply a bitwise computation to the data bits in the transposed data words, and to retranspose the data words following the bitwise computation for output from the device. Additionally or alternatively, the computational section may be configured to perform a neighborhood operation on the data by processing the data bits held in a first row of the associative memory cells together with the data bits in at least one shifted replica of the first row that is held in at least a second row of the associative memory cells.

Typically, the computational section is configured to write the data bits to a set of the associative memory cells, selected responsively to the comparison, in one of the rows while leaving the data held in the remaining memory cells in the one of the rows unchanged.

There is also provided, in accordance with an embodiment of the present invention, a method for computing, which includes accepting and executing at least one command from a host processor to a memory device, the at least one command including a write command to store data at a specified address in an array of random access memory (RAM) cells formed on a semiconductor substrate in the memory device. Responsively to the at least one command, the data are transferred into a computational section of the memory device, the computational section including associative memory cells, which are disposed on the semiconductor substrate in communication with the array of the RAM cells, and an associative computation is performed on the data in the computational section.

Typically, the at least one command includes a second command from the host processor to the memory device, which causes the computational section to perform the associative computation on the data.

There is additionally provided, in accordance with an embodiment of the present invention, an integrated circuit device, including a semiconductor substrate and an array of random access memory (RAM) cells, which are disposed on the substrate and are configured to store data. A computational section includes associative memory cells, which are disposed on the substrate in communication with the array of the RAM cells. Control logic in the device is configured to accept and execute first commands from a host processor specifying read and write operations to be performed on the data in the RAM cells, and to accept second commands from the host processor, which cause the computational section to perform associative computations on the data.

In a disclosed embodiment, the control logic is configured to cause the computational section to selectively write data bits to a set of the memory cells in a row of the device while leaving the data held in the remaining memory cells in the row unchanged.

There is further provided, in accordance with an embodiment of the present invention, a method for computing, which includes providing a memory device including an array of random access memory (RAM) cells, which are disposed on a semiconductor substrate and are configured to store data, and including a computational section, which includes associative memory cells, which are disposed on the substrate in communication with the array of the RAM cells. In response to first commands from a host processor to the memory device, read and write operations are performed on the data in the RAM cells. In response to second commands from the host processor to the memory device, associative computations are performed on the data in the computational section.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a memory device, in accordance with an embodiment of the present invention;

FIG. 2 is a block diagram that schematically illustrates a memory bank with a computational section, in accordance with an embodiment of the present invention;

FIG. 3 is a block diagram that schematically illustrates a memory bank with a computational section, in accordance with another embodiment of the present invention;

FIG. 4 is a block diagram that schematically shows a part of a memory bank that includes a computational section, in accordance with an embodiment of the present invention;

FIG. 5 is a block diagram that schematically shows details of a computational section of a memory bank, in accordance with an embodiment of the present invention;

FIG. 6 is a block diagram that schematically shows details of a command sequencer, in accordance with an embodiment of the present invention;

FIG. 7 is a block diagram that schematically illustrates a computation performed by a computational section in a memory, in accordance with an embodiment of the present invention;

FIG. 8 is a flow chart that schematically illustrates a method for performing a computation, in accordance with an embodiment of the present invention;

FIG. 9 is a block diagram that schematically illustrates a method for performing a neighborhood computation using a computational section in a memory array, in accordance with an embodiment of the present invention;

FIG. 10 is a schematic circuit diagram illustrating a column of cells in a computational section of a memory array, in accordance with an embodiment of the present invention;

FIG. 11 is a schematic circuit diagram showing details of a storage cell and compare logic in a computational section of a memory array, in accordance with an embodiment of the present invention; and

FIG. 12 is a schematic circuit diagram showing details of tag logic in a computational section of a memory array, in accordance with an embodiment of the present invention.

### DETAILED DESCRIPTION OF EMBODIMENTS

### Overview

In embodiments of the present invention that are described hereinbelow, a memory device comprises RAM along with one or more special sections containing associative memory cells, which may be used to perform parallel computations at high speed. Integrating these associative sections into the memory device together with the RAM minimizes the time needed to transfer data into and out of the associative sections, and thus enables the device to perform logical and arithmetic operations on large vectors of bits far faster than would be possible in conventional processor architectures.

The associative cells are functionally and structurally similar to CAM cells, in that comparators are built into each associative memory section so as to enable multiple multi-bit data words in the section to be compared simultaneously to a multi-bit comparand. (The associative cells differ from conventional CAM cells, however, in that they permit data to be written to selected cells, as described hereinbelow, without necessarily changing the values in neighboring cells.) These comparisons are used in the associative memory section as the basis for performing bit-wise operations on the data words.

As explained in the related U.S. patent application and in the thesis by Akerib that are cited above, these bit-wise operations serve as the building blocks for a wide range of arithmetic and logical operations, which can thus be performed in parallel over multiple words in the associative memory section. Such operations are referred to herein as associative computations. This term is defined, in the context of the present patent application and in the claims, to mean an operation that is performed in parallel over an array of bits in a memory and comprises comparison of the bits to a certain comparand followed by selective write of bit values to the memory based on the results of the comparison. A number of examples of such processing operations are described hereinbelow. Some of the operations involve data shift and transposition (interchanging rows and columns, which may also be referred to as rotation), which are also performed rapidly by the associative memory section.

As noted earlier, RAM devices are conventionally configured to accept read and write commands from a host processor that specify addresses at which data are to be read from or written to the memory array in the device. In embodiments of the present invention, this conventional command interface is augmented by computational commands, referred to herein as “Zcommands.” These Zcommands are used by the host processor to instruct the memory device to perform a specified associative operation on the data that are stored in a certain address or range of addresses in the RAM. The syntax of the Zcommands may be the same as that of conventional read and write commands, with the addition of a mode or operation code indicator.

In response to a Zcommand, the memory device transfers data from the specified RAM cells into the associative memory section, and performs a sequence of associative operations on the data (referred to herein as “micro-commands”) that implement the Zcommand. The result is transferred back to the RAM cells, where it may be read out by the host. These internal data transfers and associative operations can be very fast, since they operate simultaneously on large vectors of data and avoid the bottleneck of the host memory interface, and they may take place in parallel with other host memory access operations.

This novel memory device, with an embedded computational section or sections, may be installed in place of or in addition to conventional RAM storage devices in computers of various types (including computerized equipment such as mobile communication devices, game consoles and multimedia entertainment units). Ordinary read and write operations between a host processor and the novel memory device may take place in the conventional manner, and at the same speed as in conventional RAM devices. The computational section may be invoked by the software running on the computer as appropriate to accelerate applications that require parallel operations on large vectors of data. Some examples of such applications include graphics processing, image and video processing, data search and data mining, communication, encryption and decryption, data compression, robotics and bio-informatics.

### Hardware Configuration

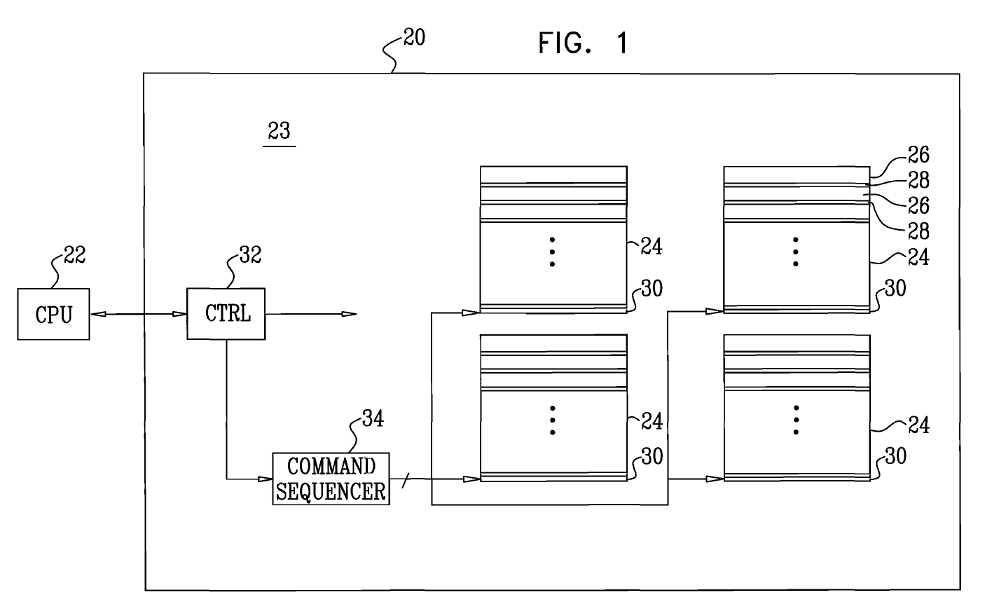

FIG. 1 is a block diagram that schematically illustrates a memory device 20, in accordance with an embodiment of the present invention. Device 20 is an integrated circuit device, which comprises a semiconductor substrate 23 on which one or more banks 24 of RAM cells are formed. Typically, device 20 comprises a single chip, formed on a single die of a semiconductor wafer. In this and the other embodiments that are described herein, device 20 is assumed to comprise synchronized dynamic RAM (SDRAM), but the principles of the present invention may similarly be applied using other types of memory cells, such as other types of DRAM or SRAM.

Each bank 24 in this embodiment comprises multiple sections 26 of DRAM cells, including rows of sense amplifiers 28, as are known in the art. Each section, for example, may comprise one or more arrays of 256 or 512 rows of DRAM cells, with 16,000 cells (2K bytes), or more, in each row. Each row is addressed by a corresponding word line, while each column of cells is addressed by a bit line, which connects to a corresponding sense amplifier for readout. In the description that follows, the terms “horizontal” and “vertical” are used, for the sake of simplicity, to refer to the respective directions of the rows and columns of memory cells in device 20, in accordance with common usage in the art. These terms themselves, however, have no intrinsic physical meaning in the context of the present invention.

In addition to the DRAM sections, each bank 24 comprises a computational section 30, which comprises a number of rows of associative memory cells and associated logic. The structure of section 30 is described hereinbelow with reference to FIG. 5, and a possible cell-level implementation of this section is shown in FIGS. 10-12. The computational section may be deployed in various ways relative to the DRAM sections, some of which are shown in FIGS. 2-4. Although only one computation section 30 is shown in each bank 24 in FIG. 1, there may alternatively be multiple computational sections in each bank, and possibly even one computational section for each section of DRAM cells. Furthermore, although all of banks 24 in memory device 20 are shown in FIG. 1 as comprising a respective computational section 30, the memory device may alternatively comprise one or more computational sections in only one or a few of the banks of memory cells, while the remaining banks are used only for data storage.

A host processor, such as a central processing unit (CPU) 22 of a computer, interacts with device 20 via an embedded memory controller 32. The controller may implement a standard memory interface, such as a double data rate (DDR) SDRAM interface, thus enabling the host processor to perform read and write operations to and from addresses in DRAM sections 26 in the conventional way. The standard memory interface of device 20, however, is augmented with a set of “Zcommands,” as noted above. These commands may be invoked by the host processor by writing specified command words to a memory-mapped command register (not shown) in device 20. The commands themselves are typically memory-mapped to addresses in the DRAM sections, thus enabling the host processor to specify a certain computational operation to be performed on the data stored at a specified address and to write the result of the operation to that address or to another specified address.

Controller 32 refers the Zcommands for execution to a command sequencer 34, which generates micro-commands to computation sections 30 that cause the Zcommands to be carried out. Details of the command sequencer are described hereinbelow with reference to FIG. 6. Although controller 32 and sequencer 34 are shown in the figures, for the sake of conceptual clarity, as separate functional blocks, the functions of the controller and sequencer may be implemented together in a single control logic unit on chip 23.

FIG. 2 is a block diagram that schematically shows one possible implementation of memory bank 24, in accordance with an embodiment of the present invention. In this implementation, the memory bank includes a storage region 40 and a computation region 42. The storage region comprises multiple sections 26 (sixty-four sections in this example) of DRAM cells, which may be used for data storage in the conventional manner. In addition, a dedicated section 44 of DRAM cells is used to store data on which computations are to be performed by computation section 30. Typically, host processor writes data on which section 30 is to operate to section 44, while storing other data in region 40.

Dedicated DRAM section 44 is coupled so as to enable rapid data transfer to and from computation section 30. Typically, an entire row of bits can be transferred at once between sections 44 and 30, in an operation requiring only one or two clock cycles.

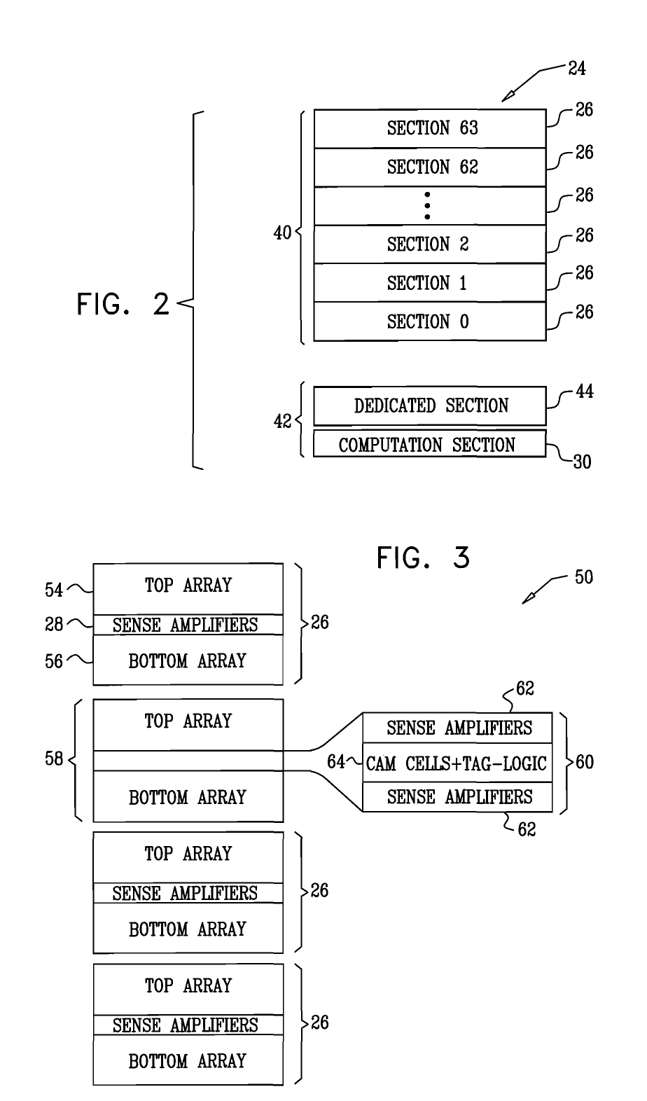

FIG. 3 is a block diagram that schematically shows another possible implementation of a memory bank 50, in accordance with an embodiment of the present invention. Memory bank 50 may be used in place of bank 24 in device 20. In bank 50, each section 26 comprises a top array 54 and a bottom array 56 of DRAM cells, separated by an array of sense amplifiers 28. The top and bottom array may each comprise 256 rows of cells, for example. This sort of arrangement is common in DRAM devices that are known in the art.

Bank 50, however, includes at least one computation region 58, comprising a central slice 60 in which a computation section 64 is sandwiched between the rows of sense amplifiers 62 of the top and bottom arrays. The computation section comprises CAM-like associative cells and tag logic, as explained hereinbelow. Data bits stored in the cells of arrays 54 and 56 in region 58 are transferred to the computation section, when required, via the sense amplifiers. This arrangement permits rapid, efficient data transfer between the storage and computation sections of region 58 in the memory device. Although FIG. 3 shows only a single computation region of this sort, two or more of storage sections 26, or even all of the storage sections, may be configured as computation regions, with a central computation section as in region 58.

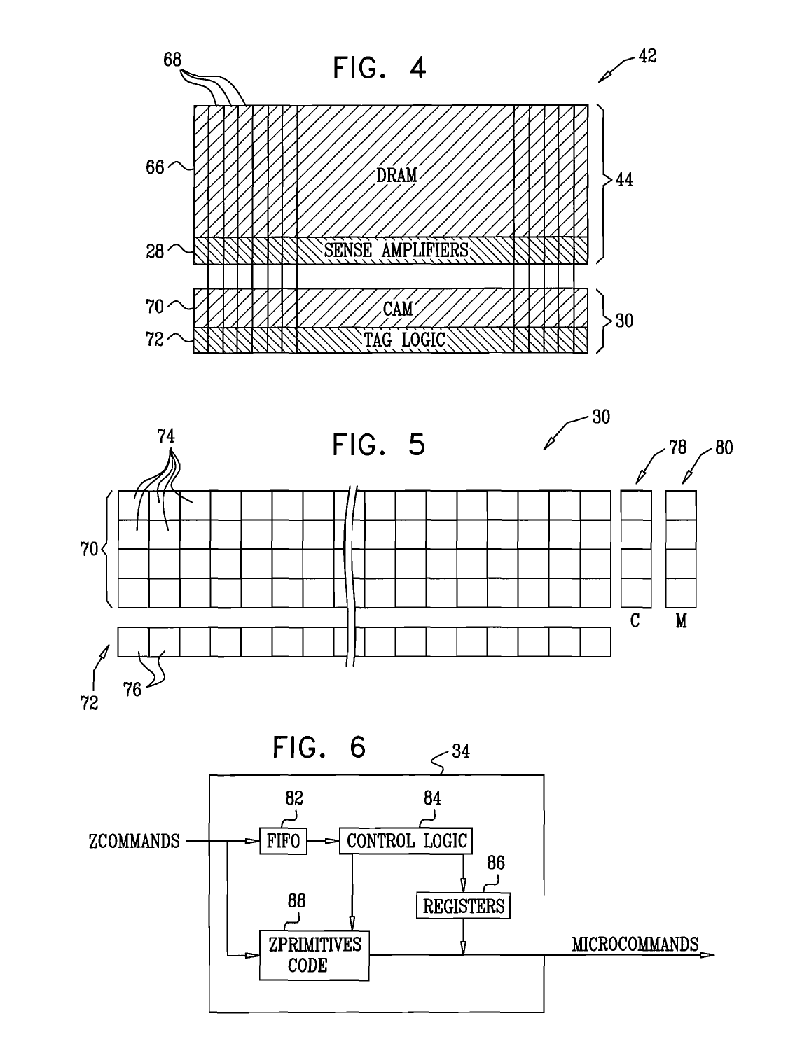

FIG. 4 is a block diagram that shows details of the organization of sections 44 and 30 in computation region 42, in accordance with an embodiment of the present invention. Section 44 comprises an array 66 of DRAM cells, which are arranged in a matrix of rows (not shown) and columns 68. Each column is served by one of sense amplifiers 28. Section 30 comprises an array 70 of CAM-like associative cells, which are likewise arranged in multiple rows and columns 68. In other words, the horizontal pitch of the associative cells (i.e., the distance by which adjacent columns are mutually spaced) in section 30 matches the pitch of the DRAM cells in section 44, and the bit lines (not shown in this figure) of columns 68 in array 66 continue through to array 70. This sort of arrangement is not mandatory, but it enhances the speed of data transfer and ease of implementation of the computation section. Section 30 also comprises a row 72 of tag logic cells, which serve as flag bits for the computations performed in section 30, as described hereinbelow.

Because the associative cells of section 30 are column-aligned with the DRAM cells in section 44, a full row of data can be loaded at once from array 66 into a row of array 70, and likewise stored from a row of array 70 back to array 66. To perform the data transfer, the word line (not shown) of the source row in question is asserted, and sense amplifiers 28 latch the data in the source row. The word line of the destination row is then asserted, thus causing the data to be transferred from the sense amplifiers via the bit lines to the destination row. The same operation is performed in reverse in order to transfer data from the associative cells in array 70 back to the DRAM. Thus, the associative cells in array 70 are directly attached to the DRAM cells in array 66, and are thus embedded in the DRAM readout circuitry without any intervening input/output (I/O) buffer.

Some operations performed by computation section 30 involve shifting the contents of a row right or left. Such shift operations may be accomplished within section 30 in operations that require only a few clock cycles. Alternatively, sense amplifiers 28 may be configured to carry out a switching function (in addition to their normal sensing function), so that upon receiving a shift command, the sense amplifiers transfer the data on their respective bit lines over to the next column. As a result, the shift is accomplished simultaneously with the data transfer operation.

FIG. 5 is a block diagram that schematically shows further details of computation section 30, in accordance with an embodiment of the present invention. Array 70 comprises multiple rows of associative cells 74 and an additional row 72 of tag cells 76. Alternatively, array 70 may comprise a smaller or larger number of rows, although typically a number of rows between three and eight gives an optimal balance between computational efficiency and consumption of chip “real estate” in device 20.

Like CAM cells, associative cells 74 contain compare logic (shown in FIG. 10), which compares the bit held in the cell to a corresponding bit value of a comparand held in a comparand register 78. When all of the bits in a column of array 70 match the values of the corresponding bits of the comparand, the compare logic sets the tag bit held in tag cell 76 for that row. Thus, row 72 indicates which columns of array 70 match the comparand. A mask held in a mask register 80 may be used to limit the comparison to certain rows: The comparison is performed only in those rows for which the mask bit is set, and the remaining rows are ignored.

Section 30 may be used to perform a wide range of data manipulations and computations, including vector addition and vector multiplication, inter alia, using a very simple and limited set of micro-commands, such as read, write, compare and shift. A number of examples of these sorts of operations are described in the next section. Other associative operations of these sorts are described in the above-mentioned related application, “Memory Device with Integrated Parallel Processing.” Although the design of the memory device that is used to implement the associative operations in that application differs from the devices that are described in the present patent application, the principles of the computations that are described in that application may also be applied, mutatis mutandis, in devices based on the principles of the present invention.

FIG. 6 is a block diagram that schematically shows details of command sequencer 34, in accordance with an embodiment of the present invention. As noted earlier, controller 32 passes Zcommands from host processor 22 to sequencer 34, which queues the commands in a first-in-first-out (FIFO) buffer 82 prior to execution. Control logic 84 interprets each command to generate a corresponding sequence of micro-commands to computation section 30. The control logic may be implemented, for example, as a finite state machine, which steps through the sequence of micro-commands corresponding to each Zcommand. The state machine and the resultant execution of the micro-commands may be driven at the normal clock rate of memory device 20, or alternatively at a faster clock rate (such as a multiple of the normal clock rate).

The micro-commands comprise command primitives (referred to as “Zprimitives”) and command parameters. The command primitives, which are held in a code memory 88, may include the following:
Read (load data) from a specified source row in array 66 into a specified target row in array 70.
Write (store data) from a specified source row in array 70 into a specified target row in array 66.
   The read and write operations actuate the corresponding word lines of the source and target rows.
Compare the bit vectors in the columns of array 70 to a comparand in comparand register 78 (possibly subject to a mask in mask register 80).
Shift the contents of the tag register left or right.
   Registers 86 contain and output the parameters required for execution of the Zprimitives, such as row numbers and comparand and mask values.

Because command sequencer 34 operates separately from controller 32, host processor 22 may continue to access memory device 20 while the command sequencer and computational section 30 carry out the required computations. In this sort of parallel operation, for example, while the computational section operates on data in one of banks 24, the host processor may write and/or read data to the other banks. When the computation has been completed, controller 32 may signal the host processor, which then reads out the result from the appropriate target location in the memory bank.

### Performing Associative Computations in the Memory Device

As a very simple sort of parallel computation, consider a command to shift all the data in a given memory row one bit to the left. This sort of operation can be carried out by computational section 30 in one to three clock cycles. Assuming the second row is to be shifted, the following command sequence may be used:

TABLE I
COMMAND SEQUENCE FOR SHIFT

| | |
|---|---|
| 1. | SET MASK (0100). |
| 2. | COMPARE (x1xx) - Compares each bit in the second row to |
| | the value “1” and sets the corresponding bit in tag row |
| | 72 if there is a match. No comparison is made in the |
| | other rows since the corresponding mask bit is not set. |
| 3. | WRITE (x0xx) - For all columns in which the tag bit is |
| | set, writes the value “0” to the second row. |
| 4. | SHIFT (−1) - Shifts the bits in the tag row one column |
| | to the left. |
| 5. | WRITE (x1xx) - for all columns in which the tag bit is |
| | set, writes the value “1” to the second row. |

The write commands in Table I are examples of “selective write” operations, i.e., specified bit values are written selectively to a set of certain bits in the row in question, while the remaining bits are unchanged. In this case, the bits are selected on the basis of the comparison results that are held in the tag row. It is also possible to write selectively from a source row of data in the computation section to a target row in the RAM section by latching the sense amplifiers only on the bit lines of the bits that are to be written to the RAM.

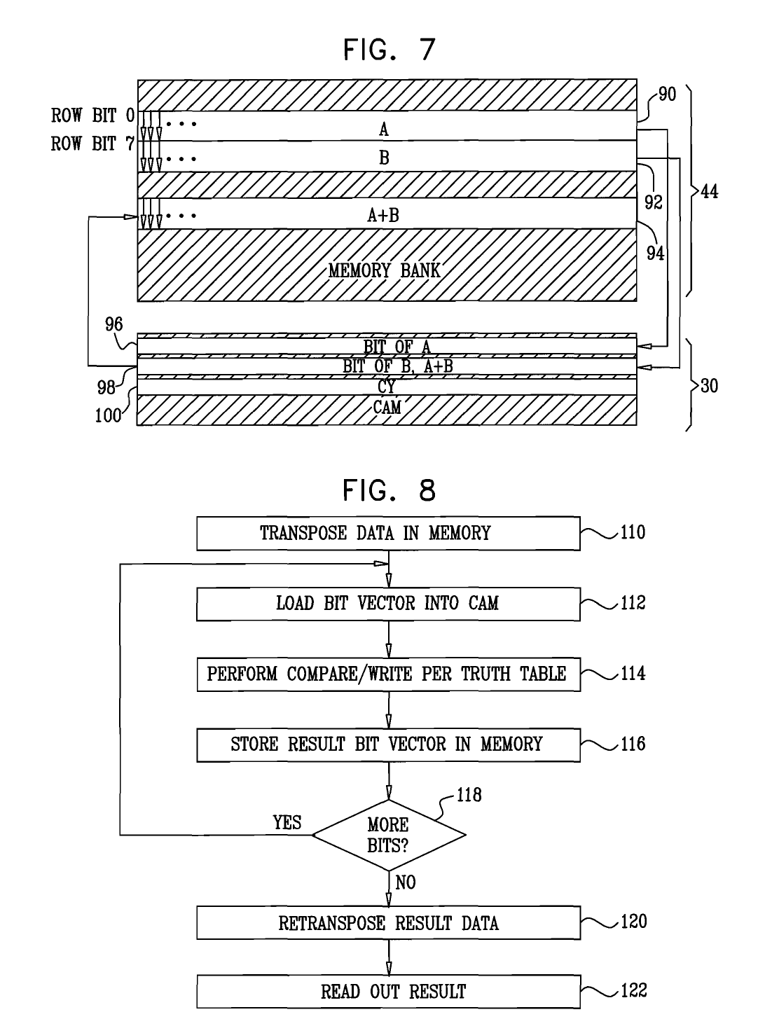

Reference is now made to FIGS. 7 and 8, which schematically illustrate a method for adding together two sets of numbers that are stored in memory device 20, in accordance with an embodiment of the present invention. FIG. 7 is a block diagram showing the storage locations of the numbers in computation region 42 in the course of the computation. FIG. 8 is a flow chart that presents key steps in the method. The method is shown and described here just as one illustrative example of parallel arithmetic operations that may be carried out using a memory device with a computational section. Other sorts of computations that may be carried out using associative operations in the sorts of device architectures that are described above are also considered to be within the scope of the present invention.

In the example shown in FIGS. 7 and 8, device 20 receives a command from host 22 to sum a first array of data words (marked “A”), stored in a region 90 of section 44, with a second array of data words (marked “B”) stored in a region 92, and to write the result (“A+B”) to a region 94. The data words are assumed to be eight-bit numbers, with the least significant bit (LSB) referred to as “BIT 0”, and the most significant bit (MSB) referred to as “BIT 7,” and it is accordingly convenient (for reasons that will become clear below) that sections 90, 92 and 94 each contain eight rows of memory cells. The principles of the method described here, however, may equally be applied to numbers of any length and regions of any size. The numbers in regions 90 and 92 are summed in computational section 30 bit by bit, from LSB to MSB, using a row 96 in section 30 to hold the appropriate bits from A; a row 98 to hold the appropriate bits from B, which are then replaced by the bitwise sum A+B; and a row 100 to hold an interim carry bit (CY), which is carried forward from each bit to the next more significant bit.

Initially, host processor 22 writes the arrays of data words to regions 90 and 92 in the conventional row-wise manner, with each word occupying one byte (eight consecutive cells), arranged sequentially in the rows of the appropriate region. In order to perform the summation efficiently in section 30, the words in regions 90 and 92 are first transposed, in a transposition step 110. Following this step, the bits of each word are ordered sequentially in a single column, from LSB to MSB, as indicated by the vertical arrows in FIG. 7. The effect of the transposition is shown below in Tables II and III, wherein Table II shows the positions of the bits of each data word (<a0, . . . , a7>, <b0, . . . , b7>, . . . , <x0, . . . , x7>, <y0, . . . , y7>, . . . ) before transposition, and Table III shows the positions after transposition:

TABLE II
OPERANDS BEFORE TRANSPOSITION

| | | | | | | | | | | | | | | | | | |
|---|---|---|---|---|---|---|---|---|---|---|---|---|---|---|---|---|---|
| a0 | a1 | a2 | a3 | a4 | a5 | a6 | a7 | b0 | b1 | b2 | b3 | b4 | b5 | b6 | b7 | c0 | c1 |
| x0 | x1 | x2 | x3 | x4 | x5 | x6 | x7 | y0 | y1 | y2 | y3 | y4 | y5 | y6 | y7 | z0 | z1 |
| . . . | . . . | . . . | . . . | . . . | . . . | . . . | . . . | . . . | . . . | . . . | . . . | . . . | . . . | . . . | . . . | . . . | . . . |
| . . . | . . . | . . . | . . . | . . . | . . . | . . . | . . . | . . . | . . . | . . . | . . . | . . . | . . . | . . . | . . . | . . . | . . . |

TABLE III
OPERANDS AFTER TRANSPOSITION

| | | | | | | | | | | | | | | | | | |
|---|---|---|---|---|---|---|---|---|---|---|---|---|---|---|---|---|---|
| a0 | x0 | . . . | . . . | . . . | . . . | . . . | . . . | b0 | y0 | . . . | . . . | . . . | . . . | . . . | . . . | c0 | z0 |
| a1 | x1 | . . . | . . . | . . . | . . . | . . . | . . . | b1 | y1 | . . . | . . . | . . . | . . . | . . . | . . . | c1 | z1 |
| a2 | x2 | . . . | . . . | . . . | . . . | . . . | . . . | b2 | y2 | . . . | . . . | . . . | . . . | . . . | . . . | c2 | z2 |
| . . . | . . . | . . . | . . . | . . . | . . . | . . . | . . . | . . . | . . . | . . . | . . . | . . . | . . . | . . . | . . . | . . . | . . . |

The transposition may be accomplished efficiently by loading the rows of the data words in regions 90 and 92 into computational section 30 one by one, and performing the following compare-write-shift routine, under the control of command sequencer 34 and using tag logic 72 in the manner described above:

TABLE IV
TRANSPOSITION PSEUDO0CODE

| | |
|---|---|
| 1. | Load L1 with “1” in each bit location j, “0” elsewhere; |
| 2. | For (j=0; j < 8, j++) |
| 3. | { |
| 4. | Load row j from memory into L0 with offset j; |
| 5. | For (i=0; i < 8, i++) |
| 6. | { |
| 7. | Compare (L0,L1); Write to L(i+3); |
| 8. | Shift Left L0; |
| 9. | } |
| 10. | Shift Right L1; |
| 11. | } |

In the code above, the successive rows in section 30 are labeled L0, L1, L2, . . . , the bit locations along each row are labeled (0, 1, 2, 3, 4, 5, 6, 7, 0, 1, 2, 3, 4, 5, 6, 7, 0, . . . ). Line 1 of the code thus loads L1 with the vector (1,0,0,0,0,0,0,0,1,0,0,0,0,0,0,0,1, . . . ), and line 10 shifts this vector one column to the right in each iteration. The “Compare” operation in line 7 is a bitwise comparison, which causes a “1” to be written to the corresponding bit position in L(i+3) when the bits of L0 and L1 match, and “0” otherwise. After the transposition is complete, the transposed operands are copied back to region 90 or 92 as appropriate.

The code above assumes, for the sake of simplicity, that section 30 has a sufficient number of rows to contain all eight bits of all the transposed data words. Alternatively, if section 30 does not have a sufficient number of rows, the transposition may be carried out four bits at a time, for example, or even in smaller segments. Further alternatively, the transposition may be carried out in software or using techniques described in the above-mentioned patent application entitled “Memory Device with Integrated Parallel Processing.”

After the data in regions 90 and 92 have been transposed, command sequencer 34 instructs computational section 30 to load the first row from each of the regions into rows 96 and 98 of the computational section, respectively, at a vector loading step 112. As a result, the LSBs of all of the data words in A are loaded into row 96, and the LSBs of all the data words in B are loaded into row 98. The computational section then performs a bitwise addition on each pair of bits in rows 96 and 98 and overwrites the data in row 98 with the result, at an addition step 114. The addition step is carried out by a combination of compare and write operations, using a truth table that implements bitwise addition, as described below. When appropriate, a carry bit (CY) is written to row 100, and this carry bit is then used in the next iteration through step 114. The computation section then writes the result in row 98 back to the corresponding row in region 94, at a vector storing step 116, and goes on to process the remaining rows of regions 90 and 92 in order until all bits have been summed, at a new iteration step 118.

It can be shown that the bitwise addition performed at step 114 can be expressed by the following truth table:

TABLE V
TRUTH TABLE FOR ADDITION

| | |
|---|---|
| INPUT | OUTPUT |

| A | B | CY | A + B | CY |
|---|---|---|---|---|
| 0 | 0 | 1 | 1 | 0 |
| 0 | 1 | 1 | 0 | 1 |
| 1 | 1 | 0 | 0 | 1 |
| 1 | 0 | 0 | 1 | 0 |

In other words, if the bits in (A, B, CY) in a given column of computational section 30 match the input pattern in one of the rows of Table V, then the resulting values (A+B, CY) in that row of the table are written to the corresponding bit positions in rows 98 and 100 of computational section 30. The order of the comparisons is important, i.e., to give the correct result, the comparands should be loaded into register 78 and the corresponding results written to rows 98 and 100 in the order of the rows in Table V. Mask register 80 is not needed explicitly in this computation, i.e., the mask value is (1, 1, 1). Although there are four other possible combinations of input bit values (A, B, CY) that are not listed in Table V, these other combinations are omitted from the table and need not be tested, because they leave the corresponding bit values in rows 98 and 100 unchanged.

The sequence of operations performed by computation section 30 may be expressed in pseudocode as follows:

TABLE VI
PSEUDOCODE FOR BITWISE ADDITION

1. Compare(0,0,1); Write(0,1,0)
2. Compare(0,1,1); Write(0,0,1)
3. Compare(1,1,0); Write(1,0,1)
4. Compare(1,0,0); Write(1,1,0)

In each line of the code, the write operation is executed if the result of the comparison is TRUE. Executing each line of the code requires one clock cycle, meaning that if there are 16,000 cells in each row of section 30, the addition itself is performed at a rate of 4K bits per cycle. The other operations involved in the method of FIG. 8 are similarly rapid, typically taking no more than one or two clock cycles each.

Other sorts of arithmetic and logical operations may similarly be carried out in computational section 30 using sequences of compare and write operations given by appropriate truth tables. The theory of these truth tables and practicalities of their use are described further in the above-mentioned related patent application and thesis by Akerib.

After the results of the bitwise addition for all of the rows in regions 90 and 92 have been written back to region 94, the data in this region are retransposed back to the conventional row-wise representation, at a retransposition step 120. The retransposition is carried out in essentially the same manner as were the transpositions at step 110. Controller 32 then reads out the result to host processor 22, at a data readout step 122.

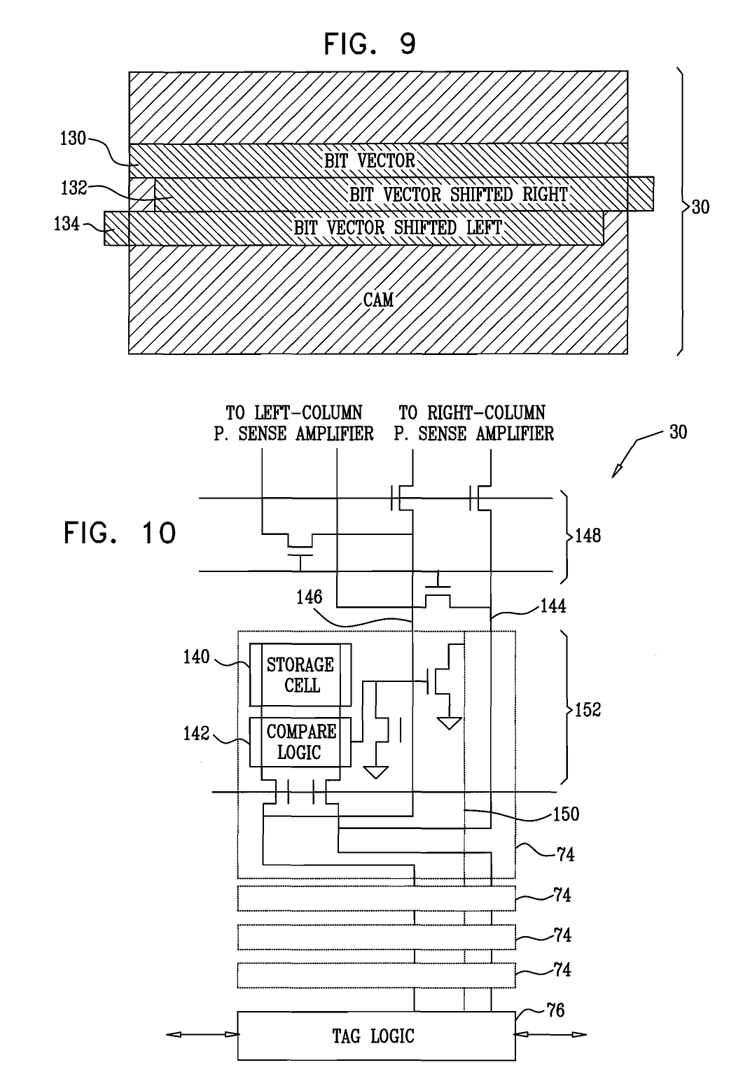

FIG. 9 is a block diagram that schematically illustrates a method for performing a neighborhood computation in computational section 30, in accordance with an embodiment of the present invention. Neighborhood operations, typically involving sequences of additions and multiplications of neighboring bit values, are common in image and signal processing, for example. To facilitate such operations, computational section 30 creates two replicas of an input bit vector that is held in a row 130 of the computational section: one replica in which the bits are shifted one position to the right, in a row 132; and another in which the bits are shifted one position to the left, in a row 134. The shifts may each be accomplished, in one to three clock cycles, in the manner shown above in Table I. Larger shifts may be produced simply by repeating the shift procedure.

After the shifted replicas have been created, the computational section can perform a neighborhood operation on each bit in row 130 by applying an appropriate truth table to the column containing the bit. Other, more complex neighborhood operations may be performed using combinations of the techniques described above. Neighborhood operations typically are computationally complex, but the ability of computational section 30 to process many (for example, 16K) bits in parallel reduces drastically the number of computational clock cycles needed to perform such operations on large arrays of data values.

### Cell-Level Architecture

The functions of computational section 30 may be realized using CAM designs that are known in the art. CAM cells, however, are typically larger than DRAM cells, since they contain compare logic in addition to a data storage cell. For rapid data transfer to and from the computational section and efficient use of chip real estate, it is desirable that the columns of section 30 be aligned with the columns of the RAM storage section (such as section 44 in FIG. 4) that holds the data on which the computational section is to operate. The same bit lines may then run through each column the RAM section and a corresponding column of the associative cells in the computational section.

Therefore, in some embodiments of the present invention, the shape of the associative cells and their logic is designed to match the horizontal pitch of the RAM columns, so that the columns of associative cells are aligned with the RAM columns. The alignment may be one-to-one, i.e., with a column of associative cells for each RAM column, so that the columns of the associative cells have the same pitch as the RAM columns. Alternatively, the alignment may be n-to-one, with a column of associative cells serving n (two or more) columns of RAM by means of suitable selection logic connected to the RAM bit lines, so that the pitch of the columns of the associative cells is an integer (n) multiple of the pitch of the RAM columns. One such design, in which each column of associative cells serves two adjacent RAM columns, is shown by way of example in the figures that follow, but alternative designs that achieve the same end are also considered to be within the scope of the present invention.

FIG. 10 is a schematic circuit diagram illustrating a column of associative cells 74 in computational section 30, in accordance with an embodiment of the present invention. This figure assumes, by way of illustration, that section 30 contains four rows of associative cells 74 and a row of tag logic cells 76. Only one of the associative cells is shown in detail (and the other cells are assumed to be substantially identical). The tag logic cell is shown in detail in FIG. 12.

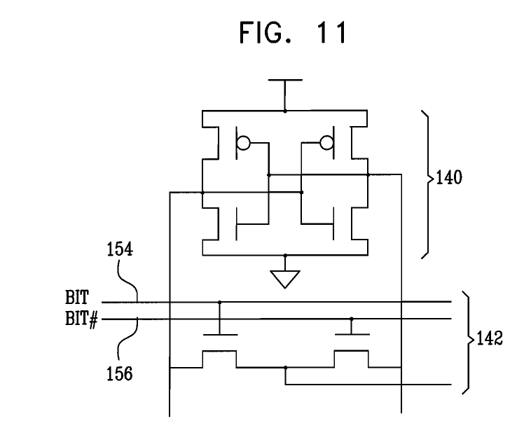

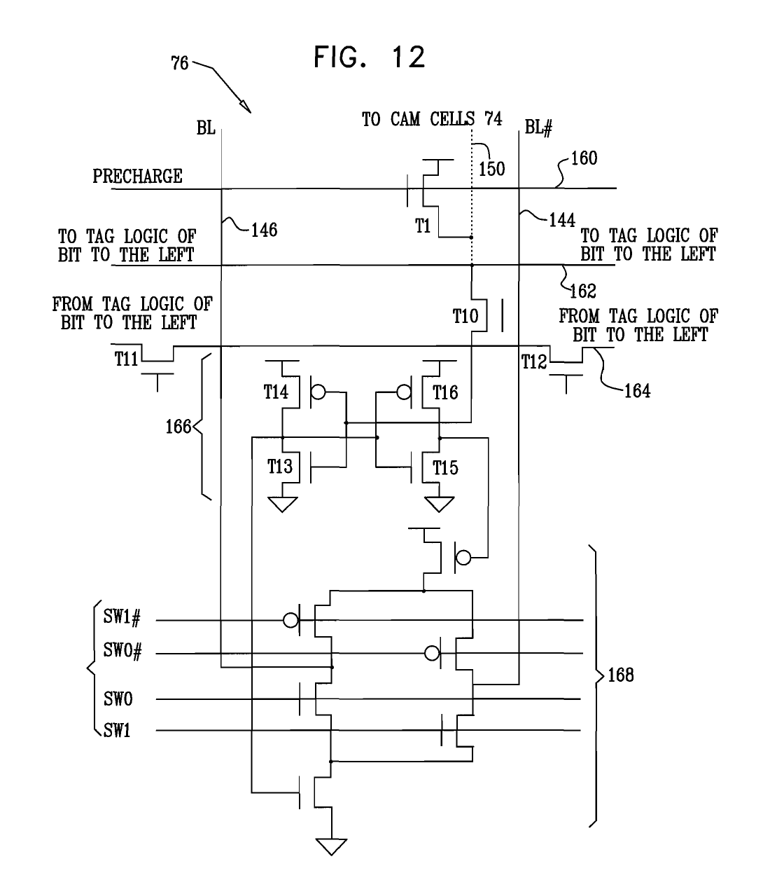

Bit lines 144 and 146 (corresponding to BL# and BL) of cell 74 are connected by selection logic 148 to primary sense amplifiers 28 in two corresponding columns of RAM section 44. Cell 74 comprises a storage cell 140 and compare logic 142. (Details of these components are shown in FIG. 11.) Switching logic 152 couples the compare logic selectively to bit lines 144 and 146 and to a diffusion line 150, which is connected to tag logic 76.

FIG. 11 is a schematic circuit diagram that shows details of storage cell 140 and compare logic 142, in accordance with an embodiment of the present invention. The storage cell is similar in structure to a conventional DRAM sense amplifiers. The compare logic compares the contents of the storage cell to the bit value (BIT) in the corresponding cell of comparand register 78, which is asserted on lines 154 and 156. When a given bit is masked (by entering a zero value in the corresponding bit of mask register 80), both of lines 154 and 156 are held at the value zero.

FIG. 12 is a schematic circuit diagram that shows details of tag cell 76, in accordance with an embodiment of the present invention. Compare logic 142 in associative cells 74 is precharged from a precharge line 160 via a transistor T1 and diffusion line 150. In the next clock phase, the diffusion line will be discharged if the stored values in cells 74 do not match the comparand. A storage cell 166 in tag cell 76 receives and holds the result of the comparison that appears on the diffusion line. The comparison value, or its complement, can be written back to one or more of the associative cells via switching logic 168 and bit lines 144 and 146, in accordance with the write commands provided by command sequencer 34.

Row lines 162 and 164 connect tag cell 76 to its right and left neighbors. The contents of the tag cells can then be shifted left or right by appropriately switching transistors T10, T11 and T12.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An integrated circuit device comprising:
a semiconductor substrate;
an array of random access memory (RAM) cells, which are arranged on the substrate in first columns and are configured to store data; and
a computational section comprising associative memory cells, which are arranged on the substrate in second columns, which are aligned with respective first columns of the RAM cells and are in communication with the respective first columns so as to receive the data from the array of the RAM cells and to perform an associative computation on the data.

2. The device according to claim 1, wherein the RAM cells comprise dynamic RAM (DRAM) cells.

3. The device according to claim 1, wherein the computational section is configured to return a result of the associative computation to the array of the RAM cells.

4. The device according to claim 3, and comprising control logic, which is coupled to receive a command from a host processor invoking the associative computation, and to issue, responsively to the command, a sequence of micro-commands that cause the computational section to perform the associative computation, and to return the result to the array of the RAM cells.

5. The device according to claim 1, and comprising control logic, which is configured to accept first commands from a host processor specifying addresses for reading and writing of the data in the array of the RAM cells, and to accept second commands, which cause the computational section to perform the associative computation on the data.

6. The device according to claim 5, wherein the second commands are memory-mapped to the addresses in the array of the RAM cells.

7. The device according to claim 1, wherein the first columns comprise first bit lines, each first column comprising a respective first bit line coupled to the RAM cells in the first column and a respective sense amplifier coupled to the first bit line, and wherein each second column comprises a respective second bit line, which is coupled to the respective sense amplifier of at least one of the first columns.

8. The device according to claim 7, wherein the RAM cells and associative memory cells are arranged in respective first and second rows, and wherein the sense amplifiers are configured to transfer the data simultaneously via the bit lines between the RAM cells in one of the first rows and all of the associative memory cells in one of the second rows.

9. The device according to claim 1, wherein the first columns are mutually spaced by a predetermined first pitch, and wherein the second columns are mutually spaced by a second pitch, which is equal to the first pitch.

10. The device according to claim 1, wherein each of the associative memory cells comprises a storage cell, for holding a data bit, and compare logic, for performing a comparison between the data bit and a respective bit value of a comparand, and wherein the second columns comprise respective tag cells, such that a tag cell in each second column is coupled to receive a result of the comparison from the compare logic and to write a new bit value to the storage cell of at least one of the associative memory cells in the second column responsively to the comparison.

11. The device according to claim 10, wherein the tag cells are coupled to transfer and receive data bits to and from the tag cells in neighboring columns, so as to apply a shift to the data.

12. The device according to claim 1, wherein the associative memory cells are arranged in multiple rows and columns, and
wherein the computational section comprises a comparand register, for holding a comparand, and is configured to make a comparison between the data held in each of the columns and the comparand, and to write data bits to one or more of the associative memory cells responsively to a result of the comparison.

13. The device according to claim 12, wherein the computational section comprises a mask register, for holding a mask, and is configured to limit the comparison to the rows that are indicated by the mask.

14. The device according to claim 12, wherein the computational section is configured to write the data bits, responsively to the result of the comparison, so as to shift the data bits along at least one of the rows of the associative memory cells.

15. The device according to claim 14, wherein the data stored in the array of the RAM cells comprise a sequence of data words, and wherein the computational section is configured to read, compare and shift the data bits in the data words so as to transpose the data words from a row-wise to a column-wise orientation.

16. The device according to claim 15, wherein the computational section is configured to apply a bitwise computation to the data bits in the transposed data words, and to retranspose the data words following the bitwise computation for output from the device.

17. The device according to claim 14, wherein the computational section is configured to perform a neighborhood operation on the data by processing the data bits held in a first row of the associative memory cells together with the data bits in at least one shifted replica of the first row that is held in at least a second row of the associative memory cells.

18. The device according to claim 12, wherein the computational section is configured to write the data bits to a set of the associative memory cells, selected responsively to the comparison, in one of the rows while leaving the data held in the remaining memory cells in the one of the rows unchanged.

19. A method for computing, comprising:
accepting and executing at least one command from a host processor to a memory device, the at least one command comprising a write command to store data at a specified address in an array of random access memory (RAM) cells formed on a semiconductor substrate in the memory device;
responsively to the at least one command, transferring the data into a computational section of the memory device, the computational section comprising associative memory cells, which are disposed on the semiconductor substrate in communication with the array of the RAM cells; and
performing an associative computation on the data in the computational section.

20. The method according to claim 19, wherein the at least one command comprises a second command from the host processor to the memory device, which causes the computational section to perform the associative computation on the data.

21. The method according to claim 20, wherein the second command is memory-mapped to the specified address in the array of the RAM cells.

22. The method according to claim 19, wherein the RAM cells comprise dynamic RAM (DRAM) cells.

23. The method according to claim 19, and comprising returning a result of the associative computation from the computational section to the array of the RAM cells.

24. The method according to claim 23, wherein performing the associative computation comprises receiving a command from a host processor invoking the associative computation, and issuing within the memory device, responsively to the command, a sequence of micro-commands that cause the computational section to perform the associative computation, and to return the result to the array of the RAM cells.

25. The method according to claim 19, wherein the RAM cells are arranged in the array in first columns, and wherein the associative memory cells are arranged in second columns, which are aligned with respective first columns of the RAM cells and are in communication with the respective first columns.

26. The method according to claim 25, wherein the first columns comprise first bit lines, each first column comprising a respective bit line coupled to the RAM cells in the first column and a respective sense amplifier coupled to the first bit line, and wherein each second column comprises a respective second bit line, which is coupled to the respective sense amplifier of at least one of the first columns.

27. The method according to claim 26, wherein the RAM cells and associative memory cells are arranged in respective first and second rows, and wherein transferring the data comprises conveying the data simultaneously via the bit lines between the RAM cells in one of the first rows and all of the associative memory cells in one of the second rows.

28. The method according to claim 25, wherein the first columns are mutually spaced by a predetermined first pitch, and wherein the second columns are mutually spaced by a second pitch, which is equal to the first pitch.

29. The method according to claim 25, wherein each of the associative memory cells comprises a storage cell, for holding a data bit, and compare logic, for performing a comparison between the data bit and a respective bit value of a comparand, and wherein the second columns comprise respective tag cells, and
wherein performing the associative computation comprises receiving in a tag cell in each second column a result of the comparison from the compare logic, and writing a new bit value from the tag cell to the storage cell of at least one of the associative memory cells in the second column responsively to the comparison.

30. The method according to claim 29, wherein performing the associative computation comprises transferring data bits between the tag cells in neighboring columns, so as to apply a shift to the data.

31. The method according to claim 19, wherein the associative memory cells are arranged in multiple rows and columns, and wherein the computational section comprises a comparand register, for holding a comparand, and
wherein performing the associative computation comprises making a comparison between the data held in each of the columns and the comparand, and writing data bits to one or more of the associative memory cells responsively to a result of the comparison.

32. The method according to claim 31, wherein the computational section comprises a mask register, for holding a mask, and wherein making the comparison comprises limiting the comparison to the rows that are indicated by the mask.

33. The method according to claim 31, wherein making the comparison comprises writing the data bits, responsively to the result of the comparison, so as to shift the data bits along at least one of the rows of the associative memory cells.

34. The method according to claim 33, wherein the data stored in the array of the RAM cells comprise a sequence of data words, and wherein performing the associative computation comprises reading, comparing and shift the data bits in the data words so as to transpose the data words from a row-wise to a column-wise orientation.

35. The method according to claim 34, wherein performing the associate computation comprises applying a bitwise computation to the data bits in the transposed data words, and retransposing the data words following the bitwise computation for output from the device.

36. The method according to claim 33, wherein performing the associative computation comprises carrying out a neighborhood operation on the data by processing the data bits held in a first row of the associative memory cells together with the data bits in at least one shifted replica of the first row that is held in at least a second row of the associative memory cells.

37. The method according to claim 31, wherein writing the data bits comprises writing bit values to a set of the associative memory cells, selected responsively to the comparison, in one of the rows while leaving the data held in the remaining memory cells in the one of the rows unchanged.

38. An integrated circuit device, comprising:
a semiconductor substrate;
an array of random access memory (RAM) cells, which are disposed on the substrate and are configured to store data;
a computational section comprising associative memory cells, which are disposed on the substrate in communication with the array of the RAM cells; and
control logic, which is configured to accept and execute first commands from a host processor specifying read and write operations to be performed on the data in the RAM cells, and to accept second commands from the host processor, which cause the computational section to perform associative computations on the data.

39. The device according to claim 38, wherein the control logic is configured to cause the computational section to selectively write data bits to a set of the memory cells in a row of the device while leaving the data held in the remaining memory cells in the row unchanged.

40. A method for computing, comprising:
providing a memory device comprising an array of random access memory (RAM) cells, which are disposed on a semiconductor substrate and are configured to store data, and comprising a computational section, which comprises associative memory cells, which are disposed on the substrate in communication with the array of the RAM cells;
in response to first commands from a host processor to the memory device, performing read and write operations on the data in the RAM cells; and
in response to second commands from the host processor to the memory device, performing associative computations on the data in the computational section.

41. The method according to claim 40, wherein performing the associative computations comprises selectively writing data bits to a set of the memory cells in a row of the device while leaving the data held in the remaining memory cells in the row unchanged.
